(19) United States
(12) Patent Application Publication
(10) Pub. No.: US 2021/0336692 A1
(43) Pub. Date: Oct. 28, 2021

(54) Wireless LAN Access Point from Space and Wireless LAN System Using the Same

(71) Applicant: Thomas Kyo CHOI, Los Angeles, CA (US)

(72) Inventor: Thomas Kyo CHOI, Los Angeles, CA (US)

(21) Appl. No.: 15/929,329

(22) Filed: Apr. 27, 2020

(51) Int. Cl. H04B 7/185; H04B 7/08

(52) U.S. Cl. CPC H04B 7/18567; H04W 84/12; H04B 7/086; H04B 7/18521

(57) ABSTRACT

A wireless local area network (WLAN) access point (AP) from Space is realized by a satellite system having low or medium earth orbit satellites configured as a multihop communication network. Ground-station-connecting (GSC) satellites in the system are communicable with a ground station (GS) connected to the Internet. An individual satellite is configured to communicate with WLAN mobile stations (MS's) visible to this satellite under a preselected WLAN communication protocol such as WiFi 6, forming the WLAN AP from Space for enabling an individual MS to access the Internet without a nearby terrestrial Internet-connected AP. The WLAN AP from Space is used with a local router on Earth to form a WLAN system. The local router relays data communicated between the AP from Space and terrestrial MS's, and uses an antenna array formed with substantially-spherical body frame with horn-antenna elements mounted and distributed thereon for omni-directional tracking of a satellite.

### LIST OF ABBREVIATIONS

AP Access point

DOA Direction-of-arrival

FOV Field of view

GEO Geostationary earth orbit

GS Ground station

GSC Ground-station-connecting

HEO Highly elliptical orbit

LAN Local area network

LEO Low earth orbit

MS Mobile station

STG Satellite-to-ground

WLAN Wireless local area network

### FIELD OF THE INVENTION

The present invention relates to a satellite system configured to provide a WLAN AP from Space for enabling MS's on Earth to access the Internet, and a WLAN system employing the WLAN AP from Space and a local router on Earth.

### BACKGROUND

WLANs, especially those operated under a WiFi protocol or an IEEE 802.11-compliant WLAN protocol, are an affordable means for accessing the Internet for people and devices such as smartphones and smart appliances. However, outside coverage zones of WLANs in populated areas, WLAN APs are hardly installed because the APs require connectivity to the Internet via fibers or other wireless communication means. In rural areas and remote less-populated areas, building terrestrial communication networks are costly. Furthermore, electrical power is required to operate the APs, so that electrical power distribution networks are also required to be available alongside with the terrestrial communication networks. As a WiFi AP has a radio coverage of less than 100 m in radius and the AP is usually mounted on a mast for maximizing the radio coverage, it is not possible to cover the entire surface of the Earth by Internet-connected WiFi towers. It is the reason that there are still close to four billion people in the world difficult to access the Internet. There are also millions of small fishing vessels out in the ocean and owned by cost-cautious fishermen who have no means of affordable communication. It would be beneficial to these fishermen if they could have access to Internet-connected WiFi APs in the middle of ocean.

KR20160116995A discloses a technique of enabling people and devices to have access to WLAN services anywhere without nearby terrestrial communication networks by deploying a GEO satellite configured to provide WLAN services and Internet access. The GEO satellite is used as a router in Space connecting terrestrial WLAN MS's and the Internet. However, the GEO satellite is at a distance of 35,786 km above the Earth's equator. One major disadvantage of using the GEO satellite as the router is a long delay experienced in data transmission between the terrestrial MS's and the Internet. Another major disadvantage is that signals transmitted from the MS's are required to have high power levels for overcoming path loss during traveling to the GEO satellite.

Reducing a latency in data transmission and a required signal power level is desirable. There is a need in the art for a satellite system for providing WLAN services and Internet access while reducing data-transmission latency and required signal power.

### SUMMARY OF THE INVENTION

A first aspect of the present invention is to provide a satellite system for realizing a WLAN AP from Space for providing WLAN services and Internet access to terrestrial WLAN MS's. When compared to using a GEO satellite as a relay in data transmission, the realized AP from Space offers a reduction of latency in data transmission between the MS's and the Internet as well as a reduction of required signal power in transmitting data from the MS's to the realized AP.

The satellite system comprises a plurality of satellites. The plurality of satellites is configured and arranged to form a multihop communication network. A plurality of GSC satellites is selected from the plurality of satellites. An individual GSC satellite is configured to communicate with a GS that connects to the Internet such that the GS is communicable with an individual satellite in the plurality of satellites through the multihop communication network and a GS-visible satellite in the plurality of GSC satellites. The GS-visible satellite is visible to the GS. The individual satellite is configured to communicate with one or more WLAN MS's located on Earth and visible to the individual satellite under a preselected WLAN communication protocol. As a result, the individual satellite forms the WLAN AP from Space for enabling an individual MS to access the Internet without a need for a terrestrial Internet-connected AP nearby the individual MS. In a first embodiment, the individual satellite is arranged to travel on an orbit that is closer to the Earth than a GEO is. The orbit may be a LEO or a MEO. In a second embodiment, the individual satellite is arranged to travel on an orbit, at least a part of which is closer to the Earth than the GEO is. The individual satellite is further arranged such that communication with the one or more WLAN MS's, and with the GS if the individual satellite also belongs to the plurality of GSC satellites, is made only when the individual satellite is traveling on said part of the orbit. In both the first and second embodiments, it reduces a latency experienced in data transmission between the individual MS and the Internet and also reduces a signal power required in transmitting data from the individual MS to the individual satellite in comparison to using a GEO satellite as a relay in data transmission.

In certain embodiments, the preselected WLAN communication protocol is an IEEE 802.11-compliant WLAN protocol. The preselected WLAN communication protocol may be WiFi 6 protocol.

In certain embodiments, the plurality of GSC satellites consists of all satellites in the plurality of satellites. That is, the plurality of GSC satellites is the plurality of satellites.

In certain embodiments, the individual satellite comprises one or more inter-satellite communication modules and a first STG communication module. The one or more inter-satellite communication modules are used for providing direct satellite-to-satellite bidirectional communication in forming the multihop communication network. The first STG communication module is used for supporting bidirectional communication with the one or more MS's. The first STG module is configured to communicate with the individual MS under the preselected WLAN communication protocol. For the individual GSC satellite, it is installed with a second STG communication module for communicating with the GS.

In certain embodiments, the first STG communication module is configured to transmit and receive signals in the S band or the C band, or both.

In certain embodiments, the second STG communication module is configured to transmit and receive signals in the Ku band, the K band, the Ka band, the V band, or a combination thereof.

The first and second STG communication modules may be configured to operate on different radio frequency bands in providing STG communication.

In certain embodiments, the one or more inter-satellite communication modules include a laser communication transceiver for enabling laser communication in Space. It is also possible that the one or more inter-satellite communication modules include a radio transceiver for enabling millimeter wave communication in the V band.

The first STG communication module may include a phased array antenna for performing adaptive beamforming in the bidirectional communication with the one or more MS's. The first STG communication module may further be configured to track a DOA of an incoming signal sent from the individual MS to the individual satellite, and to configure the phased array antenna to steer an outgoing signal transmitted from the individual satellite to the individual MS along a direction opposite to the DOA. In the individual GSC satellite, the first and second STG communication modules may share the phased array antenna for performing adaptive beamforming in communicating with the one or more MS's and in communicating with the GS.

In certain embodiments, at least one satellite in the plurality of satellites is installed with a user authentication server. The user authentication server is connected to the multihop communication network such that the user authentication server is communicable with any satellite in the plurality of satellites. The user authentication server is configured to check a user identity of the individual MS so as to determine acceptance or denial of a request from the individual MS to access the Internet through the satellite system.

A second aspect of the present invention is to provide a WLAN system for providing WLAN services to a plurality of WLAN MS's on Earth. The WLAN system comprises any of the embodiments of the disclosed satellite system, and a local router located on Earth. The satellite system is used for realizing a WLAN AP from Space. The local router is used for relaying data communicated between the WLAN AP from Space and the plurality of MS's. The local router is configured to operate as an emulated WLAN AP for communicating with the plurality of MS's, and to operate as an emulated MS for communicating with the WLAN AP from Space.

In certain embodiments, the local router is configured to track a first satellite in the plurality of satellites for directionally steering a radio beam sent from the local router toward the first satellite. The first satellite is visible to the local router and forms the WLAN AP from Space.

In certain embodiments, the local router comprises an antenna array. The antenna array is used to achieve beam steering. The antenna array comprises a body frame and a plurality of horn-antenna elements distributed and mounted on the body frame. The body frame is substantially spherical in shape. Each horn-antenna element is a horn antenna.

Other aspects of the present invention are disclosed as illustrated by the embodiments hereinafter.

### BRIEF DESCRIPTION OF THE DRAWINGS

FIG. 1 depicts an exemplary satellite system from Space having a plurality of satellites for enabling WLAN MS's on Earth to access the Internet, where the satellites form a multihop communication network.

FIG. 2 depicts typical scenarios of an individual satellite communicating with MS's on the Earth, illustrating advantages of forming a WLAN system realized with an AP from Space and a local router on Earth.

FIG. 3 depicts a schematic structure of an exemplary satellite in the satellite system.

FIG. 4 depicts an antenna array usable in implementation of the local router of the WLAN system, where the antenna array is formed with a substantially-spherical body frame having a plurality of horn-antenna elements mounted and distributed thereon.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

As used herein, “WLAN AP from Space” means a WLAN AP located in Space and primarily used for communicating with one or more MS's located on Earth.

As used herein, “LEO” is defined to be a geocentric orbit with an altitude between 80 km and 2000 km above the Earth's surface. It is also used herein that “MEO” is defined to be a geocentric orbit above the LEO and below the GEO. The GEO has an altitude of 35,786 km above the Earth's surface.

As mentioned above, using a GEO satellite as a router for connecting WLAN MS's on Earth with the Internet suffers from disadvantages of a long latency in data transmission and a need to generate high-power signals at the MS's. The two disadvantages are overcome if the router is a satellite on an orbit below the GEO, or if at least a part of the orbit is below the GEO and the satellite communicates with the ground during traveling on this part of the orbit. However, the satellite has a footprint on Earth smaller than that of the GEO satellite, and is non-stationary to a terrestrial MS. After the satellite exits from a FOV of the MS, the MS is no longer able to communicate with the satellite. Using multiple satellites is desirable to ensure continuous provision of WLAN services and to increase the total radio coverage on the Earth.

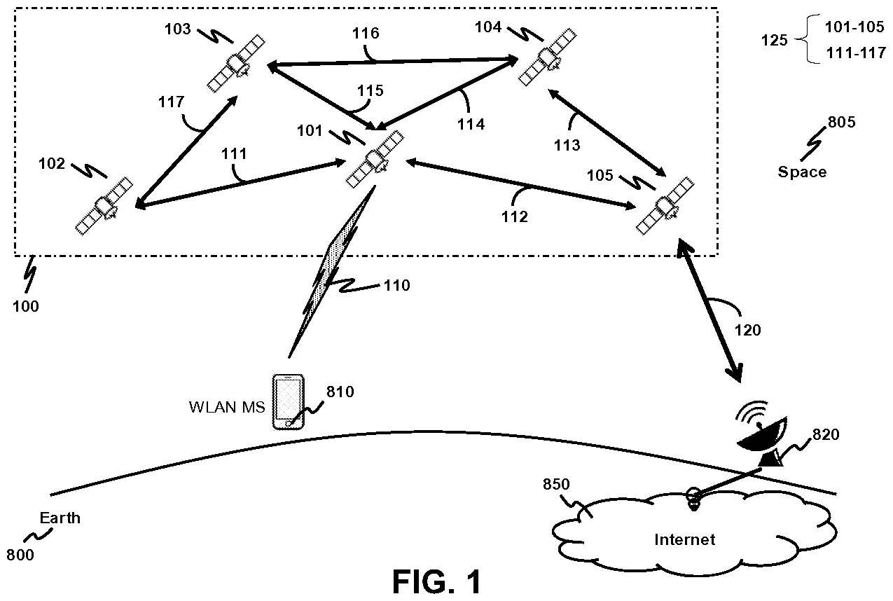

Disclosed herein is a satellite system having a plurality of satellites for realizing a WLAN AP from Space. The realized AP is used for providing WLAN services and Internet access to WLAN MS's on Earth. When compared to using a GEO satellite as a relay in data transmission, the realized AP advantageously offers a reduction of latency in data transmission between the MS's and the Internet as well as a reduction of required signal power levels in transmitting data from the MS's to the AP. The disclosed satellite system is exemplarily illustrated hereinafter with the aid of FIG. 1.

FIG. 1 depicts, in accordance with an exemplary embodiment of the present invention, a satellite system 100 in Space 805 for enabling WLAN MS's (e.g., WLAN MS 810) on Earth 800 to access the Internet 850, where satellites in the satellite system 100 form a multihop communication network. The satellite system 100 comprises a plurality of satellites 101-105. Although FIG. 1 depicts that there are five satellites for illustrating the satellite system 100, the present invention is not limited only to using five satellites in the satellite system 100; the number of satellites in forming the disclosed satellite system in accordance with the present invention may be any number greater than or equal to two.

The plurality of satellites 101-105 is configured to support inter-satellite communication such that one satellite is bidirectionally communicable with another satellite if the two satellites in Space 805 are separated by a distance that is within a communication range of each of the two satellites. Inter-satellite communication is supported by installing each of the satellites 101-105 with one or more inter-satellite communication modules. By utilizing inter-satellite communication, the plurality of satellites 101-105 is arranged to form a multihop communication network 125. The multihop communication network 125 is formed by judiciously positioning the satellites 101-105 in such a way that in the plurality of satellites 101-105, a first satellite is communicable with a second satellite directly, or indirectly via a route including at least one intermediate satellite in between. For example, the satellite 102 directly communicates with the satellite 101 via a link 111. In another example, the satellite 102 indirectly communicates with the satellite 105 via a first route created by the links 111 and 112, where the satellite 101 is an intermediate satellite for relaying messages between the satellites 102 and 105. Note that the satellites 101, 102 and 105 are judiciously positioned such that the satellite 101 is within both communication ranges of the satellites 102 and 105, and such that the satellites 102 and 105 are also within the communication range of the satellite 101. Also in this example, the satellite 102 may alternatively select a second route created by the links 117, 116 and 113 to indirectly communicate with the satellite 105, where the satellites 103 and 104 are two intermediate satellites in between. As shown in FIG. 1, the multihop communication network 125 is formed by including the satellites 101-105 and the links 111-117.

In the satellite system 100, a plurality of GSC satellites is selected from the plurality of satellites 101-105. Depending on implementation, all or part of the satellites 101-105 may be selected to form the plurality of GSC satellites. An individual GSC satellite in the plurality of GSC satellites is configured to communicate with a GS 820 that connects to the Internet 850. However, the individual GSC satellite is unable to communicate with the GS 820 if this GSC satellite travels to a position on its orbit in Space 805 not visible to the GS 820. When a certain GSC satellite is visible to the GS 820, this GSC satellite is referred to as a GS-visible satellite. The GS 820 is able to communicate with the GS-visible satellite. As an example shown in FIG. 1, the satellite 105 is a GSC satellite as well as GS-visible satellite. The satellite 105 communicates with the GS 820 through a bidirectional communication link 120. Since the individual GSC satellite is also a member in the plurality of satellites 101-105, the individual GSC satellite is connected to the multihop communication network 125. It follows that the GS 820 is communicable with each of the satellites 101-105 in the satellite system 100 through the multihop communication network 125 and the GS-visible satellite.

An individual satellite in the plurality of satellites 101-105 is configured to communicate with one or more WLAN MS's located on the Earth 800, where the one or more WLAN MS's are visible to the individual satellite. As an example shown in FIG. 1, the satellite 101 communicates with the WLAN MS 810 through a line-of-sight communication channel 110. The MS 810 is accessible to the Internet 850 through the line-of-sight communication channel 110, the satellites 101, 105, the bidirectional communication link 120 and the GS 820. As one advantage provided by the satellite system 100, the MS 810 is able to access the Internet 850 without a need for a terrestrial Internet-connected AP nearby the MS 810.

In practice, the one or more MS's communicate with WLAN APs under a certain public standard or protocol on WLAN communication. In the satellite system 100, the individual satellite is configured to communicate with the one or more MS's under a preselected WLAN communication protocol. By adopting the preselected WLAN communication protocol, the individual satellite forms a WLAN AP from Space 805 for enabling an individual MS to access the Internet 850 even if a terrestrial Internet-connected AP is not within reach of the individual MS. Preferably and practically, this WLAN communication protocol is selected to be an IEEE 802.11-compliant WLAN protocol, such as IEEE 802.11ax, which is also commonly known as WiFi 6.

In a first embodiment, the individual satellite is arranged to travel on an orbit selected to be closer to the Earth 800 than a GEO is. The orbit may be a MEO or more preferably a LEO for a greater reduction in data-transmission latency and required signal power. In a second embodiment, the orbit is selected such that at least a part of the orbit is closer to the Earth 800 than the GEO is. The orbit may be a HEO. The individual satellite is further arranged such that communication with the one or more WLAN MS's, and with the GS 820 if the individual satellite also belongs to the plurality of GSC satellites, is made only when the individual satellite is traveling on the aforesaid part of the orbit. In both the first and second embodiments, advantageously, it reduces a latency experienced in data transmission between the MS 810 and the Internet 850 and also reduces a signal power required in transmitting data from the MS 810 to the satellite 101 in comparison to using a GEO satellite as a relay in data transmission. Furthermore, the orbit needs not reside on the equatorial plane of the Earth 800. By equipping the satellite system 100 with a sufficient number of satellites, it is possible that the satellite system 100 has a full or substantial coverage of the Earth 800 in providing WLAN services.

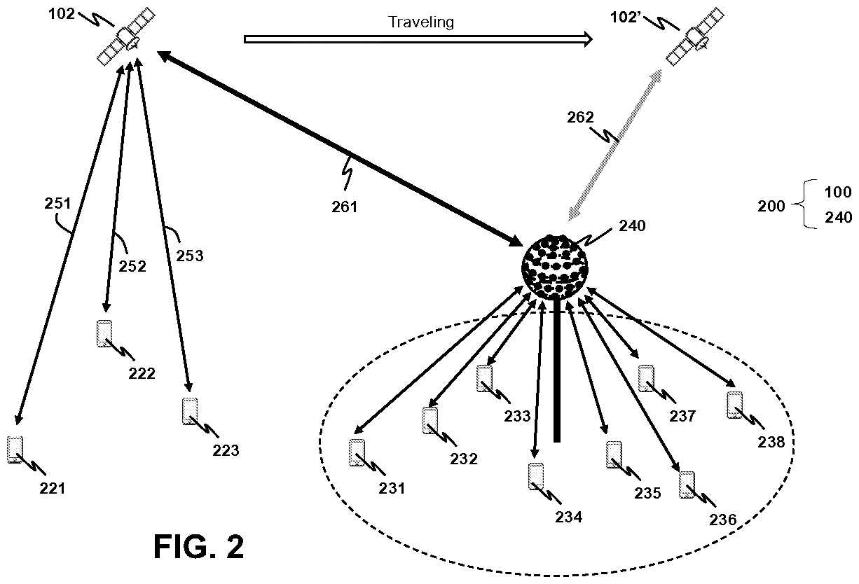

FIG. 2 depicts typical scenarios of the individual satellite communicating with the one or more MS's on the Earth 800. For illustration, consider an example situation that the satellite 102 in the satellite system 100 is visible to MS's 221-223, 231-238, and provides WLAN services to these MS's. The three MS's 221-223 are geographically distant from each other, and independently communicate with the satellite 102 through links 251-253, respectively. The eight MS's 231-238, on the other hand, are geographically close, and collectively form a WLAN user community. In communication with the satellite 102, the MS's 231-238 employ a local router 240 for relaying signals transmitted from the MS's 231-238 to the satellite 102 through a link 261 and relaying signals sent from the satellite 102 to the MS's 231-238. As the MS's 231-238 only need to communicate with the local router 240, which is located close to these MS's, signal power levels of the MS's 231-238 can be made significantly lower than signal power levels required by the other MS's 221-223, which are in direct communication with the satellite 102. Furthermore, the local router 240 can be configured to track the satellite 102 over time so as to directionally steer a transmitted radio beam toward the satellite 102 for further reducing the required signal power. This reduction in signal power is usually not enjoyable by the other MS's 221-223, which typically are equipped with omnidirectional antennas. As the satellite 102 is nonstationary to the local router 240, the local router 240 adjusts the pointing direction of the transmitted radio beam to follow the satellite 102. For example, after some time, the satellite 102 moves to another position in the sky (denoted as satellite 102′), and the local router 240 sends the radio beam along a new link 262, which is different from the original link 261.

Based on the aforementioned advantages of using the local router 240, it is additionally disclosed herein a WLAN system 200 for providing WLAN services to a plurality of WLAN MS's 231-238 on Earth 800. The WLAN system 200 comprises the satellite system 100 and the local router 240. The satellite system 100 is used for realizing a WLAN AP from Space 805. In the example shown in FIG. 2, the satellite 102 is the WLAN AP from Space 805. The local router 240 is used for relaying data communicated between the WLAN AP from Space 805 and the plurality of MS's 231-238. Preferably, the local router 240 is configured to track the WLAN AP from Space 805, viz., the satellite 102, for directionally steering a radio beam sent from the local router 240 toward the WLAN AP from Space 805.

Other implementation details of the satellite system 100 and the WLAN system 200 are elaborated as follows.

As mentioned above, all or part of the satellites 101-105 may be selected to form the plurality of GSC satellites for communicating with the GS 820, although all of the satellites 101-105 are configured to communicate with MS's. Since it is generally desirable to have a large coverage of Earth's surface for providing WLAN services, it is advantageous to configure all the satellites 101-105 in the satellite system 100 to be communicable with MS's. On the other hand, only one GS, i.e. the GS 820, is linked to the satellite system 100. (In practical scenarios, only one or a small number of GS's are used to connect to a satellite system.) Furthermore, the link 120 connecting to the GS 820 is usually heavily loaded with data traffics because all data traffics coming from and going to different MS's served by the satellite system 100 need to travel through the link 120 for access to the Internet 850. The satellite 150, which is also a GSC satellite, is costly to construct in general. It is reasonable that only part of the satellites 101-105 are used as GSC satellites, although configuring all the satellites 101-105 to be GSC satellites offers greater resilience to the satellite system 100 in case of satellite failure.

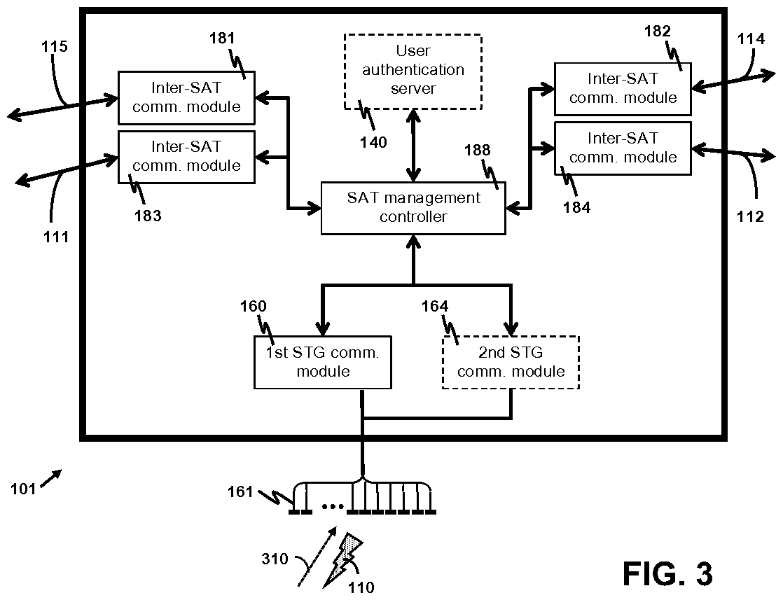

FIG. 3 depicts a schematic structure of the satellite 101 as a representative satellite for exemplarily illustrating a configuration of individual satellites used in the satellite system 100.

In the satellite 101, a first STG communication module 160 is used for supporting STG bidirectional communication so as to communicate with the MS 810 and other MS's. In general, the MS 810, which may be a hand-held mobile computing device, is power-limited. To increase the signal-to-noise ratio in signal transmission or reception, preferably the first STG communication module 160 is configured to provide adaptive beamforming. It is preferable that the first STG communication module 160 includes a phased array antenna 161 for performing adaptive beamforming in the STG bidirectional communication with one or more MS's. It is also preferable that the first STG communication module 160 is further configured to track a DOA 310 of an incoming signal sent from the MS 810 to the satellite 101 through the line-of-sight communication channel 110, and to configure the phased array antenna 161 to steer an outgoing signal transmitted from the satellite 101 to the MS 810 along a direction opposite to the DOA 310.

The first STG communication module 160 is configured to transmit and receive signals under the preselected WLAN communication protocol, such as an IEEE 802.11-compliant WLAN protocol. In one implementation option, the first STG communication module 160 is configured to transmit and receive signals under an IEEE 802.11-compliant WLAN protocol. In IEEE 802.11a/b/g/n/ac WLAN protocols, WLAN signals are operated in 2.4 GHz, 5 GHz and 5.8 GHz frequency bands. The IEEE 802.11ax WLAN protocol works on frequency bands between 1 GHz and 6 GHz. The first STG communication module 160 may be configured to transmit and receive signals in the S band, or in the C band, or both. The S band covers a range of frequencies in the radio spectrum from 2 GHz to 4 GHz. For the C band, it has a frequency range of 4 GHz to 8 GHz.

As mentioned above, inter-satellite communication is supported by installing each of the satellites 101-105 with one or more inter-satellite communication modules. For elaborating the one or more inter-satellite communication modules installed in each satellite, consider the satellite 101 depicted in FIG. 3. In the satellite 101, inter-satellite communication modules 181-184 are used for supporting the inter-satellite communication links 115, 114, 111, 112, respectively. Usually, high-speed inter-satellite communication is required. To achieve high-speed data transmission, preferably the inter-satellite communication modules 181-184 include a laser communication transceiver for enabling laser communication in Space 805. More preferably, each of the inter-satellite communication modules 181-184 is a laser communication transceiver. Alternative to laser communication, high-speed data transmission is achievable by using millimeter wave communication. The inter-satellite communication modules 181-184 may include a radio transceiver for enabling millimeter wave communication in the V band. The V band is a band of frequencies in the electromagnetic spectrum ranging from 40 to 75 GHz.

As mentioned above, each of the satellites 101-105 is installed with the first STG communication module to provide STG bidirectional communication with WLAN MS's. In this way, the MS 810 is enabled to communicate with the satellite system 100 through communicating with a visible satellite selected from the plurality of satellites 101-105. Advantageously but optionally, the satellites 101-105 are arranged to travel on orbits selected such that the MS 810 is visible to at least one of the satellites 101-105 any time. It follows that anytime when a need for WLAN services and Internet access arises, the MS 810 is able to connect to the satellite system 100.

Optionally, the satellite system 100 may be extended to include a sufficient number of satellites to achieve global coverage. Global coverage may be established in a perspective that the MS 810 is always able to “see” at least one visible satellite present for communicating with the satellite system 100 such that the MS 810 is communicable with the satellite system 100 anytime anywhere.

In practice, an individual satellite in the satellite system 100 is installed with a satellite management controller for controlling all resources in this satellite. As illustrated in FIG. 3, a satellite management controller 188 is installed in the satellite 101. The satellite management controller 188 is usually realized by a computing server or a computer.

To establish the bidirectional communication link 120, each GSC satellite selected from the plurality of satellites 101-105 is installed with a second STG communication module so as to enable this GSC satellite to communicate with the GS 820. In an illustrative case that the satellite 101 is selected to be a GSC satellite, the satellite 101 is installed with a second STG communication module 164 for communicating with the GS 820.

In certain situations, it is desirable to have a high-speed link between the GS 820 and the satellite system 100. To achieve high-speed communication, a laser-based optical communication module may be used for realizing the second STG communication module 164. It is also possible to use radio communication in achieving the high-speed link. The second STG communication module 164 is then realized with a radio transceiver. Usually, the first STG communication module 160 and the second STG communication module 164 are configured to operate on different radio frequency bands in order to, e.g., avoid mutual interference. In one implementation option, uplink and downlink signals in the bidirectional communication link 120 are transmitted at 40 GHz and 50 GHz, respectively. The second STG communication module 164 may be configured to transmit and receive signals in the Ku band, the K band, the Ka band, the V band, or a combination thereof. The Ku band covers a range of frequencies in the radio spectrum from 12 GHz to 18 GHz. The frequency range of the K band is from 18 GHz to 27 GHz. The Ka band covers a frequency range of 26.5 GHz to 40 GHz. For the V band, it has a frequency range of 40 GHz to 75 GHz.

Adaptive beaming may be used by the second STG communication module 164 in communication with the GS 820. To reduce satellite weight, preferably the first and second STG communication modules 160, 164 share the phased array antenna 161 for performing adaptive beamforming in communicating with the MS 810 and in communicating with the GS 820. It is also possible to use separate antennas for the first and second STG communication modules 160, 164.

When the MS 810 initially communicates with the satellite system 100 through the satellite 101, the satellite system 100 is required to perform a user authentication process to check if the MS 810 is authorized to use the services provided by the satellite system 100 for accessing the Internet 850. The user authentication process may be carried out by contacting a user authentication server on Earth 800. More preferably, at least one satellite in the plurality of satellites 101-105 is installed with a user authentication server for performing the user authentication process. As indicated in FIG. 3, the satellite 101 is optionally installed with a user authentication server 140 connected to the multihop communication network 125 such that the user authentication server 140 is communicable with any satellite in the plurality of satellites 101-105 for performing the user authentication process even if the MS 810 initially communicates with a satellite other than the satellite 101. The user authentication server 140 is configured to check a user identity of an individual MS initially communicating with the satellite system 100 so as to determine acceptance or denial of a request from the individual MS to access the Internet 850 through the satellite system 100.

Additional functionalities may be added to the satellite system 100. Similar to the satellite system disclosed in U.S. Pat. No. 10,587,335, earth-observation sensors may be added to one or more of the satellites 101-105 for making observations on the Earth 800. These earth-observation sensors may be: imaging sensors for imaging the Earth 800 at visible wavelengths or infrared; laser scanners for performing laser remote sensing and landscape profiling; and microwave sensors for performing microwave remote sensing and moisture/rain detection. As disclosed in U.S. patent application Ser. No. 16/525,727, computing servers may be installed and distributed over the plurality of satellites 101-105, where the servers are implemented with the Internet protocol suite and linked by the multihop communication network 125 to form a space-based Internet network. The space-based Internet network may be used as redundancy to provide temporary Internet services to the MS 810 even if the link 120 connecting to the GS 810 fails.

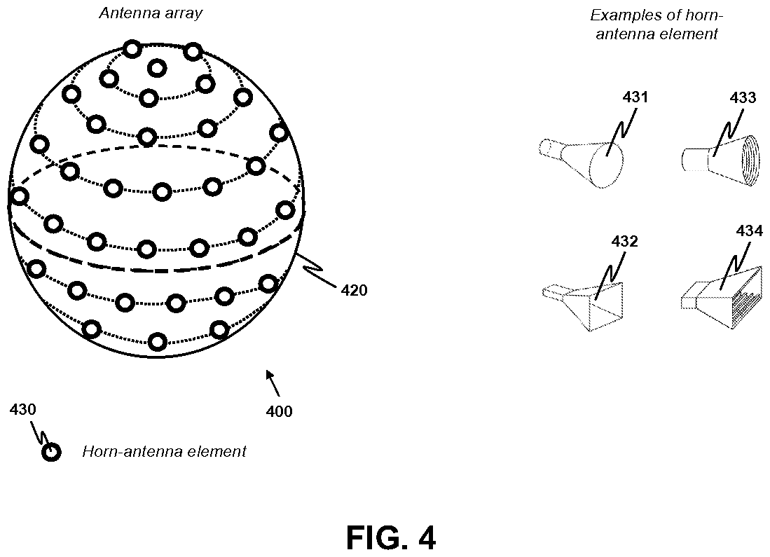

Refer to FIG. 2. In the WLAN system 200, the local router 240 may be configured to track the satellite 102. Although a phased antenna array may be installed in the local router 240 for steering a transmitted signal to propagate along the link 261, the phased antenna array usually has high power consumption. To reduce power consumption while providing beam steering, a spherical antenna array may be used. One form of spherical antenna array, to be described hereinafter, is also disclosed in a co-pending U.S. patent application Ser. No. 16/840,540 filed on Apr. 6, 2020, the disclosure of which is incorporated by reference herein. FIG. 4 depicts an antenna array 400 usable in implementation of the local router 240. The antenna array 400 is formed with a body frame 420 and a plurality of horn-antenna elements 430 distributed and mounted on the body frame 420. An individual horn-antenna element is an antenna element realized by a horn antenna. Examples of the horn antenna include a conical horn antenna 431, a pyramidal horn antenna 432, a corrugated conical horn antenna 433 and a corrugated pyramidal horn antenna 434. The body frame 420 is a rigid structure for at least supporting the plurality of horn-antenna elements 430. To provide omnidirectional tracking of the satellite 102 and to enable communication with the MS's 231-238, the body frame 420 is selected to be substantially spherical in shape.

While exemplary embodiments have been presented in the foregoing detailed description of the invention, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of steps and method of operation described in the exemplary embodiment without departing from the scope of the invention as set forth in the appended claims.

1. A satellite system for realizing a wireless local area network (WLAN) access point (AP) from Space, the satellite system comprising a plurality of satellites, wherein:
the plurality of satellites is configured and arranged to form a multihop communication network;
a plurality of ground-station-connecting (GSC) satellites is selected from the plurality of satellites, an individual GSC satellite being configured to communicate with a ground station (GS) that connects to the Internet such that the GS is communicable with an individual satellite in the plurality of satellites through the multihop communication network and a GS-visible satellite in the plurality of GSC satellites, the GS-visible satellite being visible to the GS;
the individual satellite is configured to communicate with one or more WLAN mobile stations (MS's) located on Earth and visible to the individual satellite under a preselected WLAN communication protocol, forming the WLAN AP from Space for enabling an individual MS to access the Internet without a need for a terrestrial Internet-connected AP nearby the individual MS; and
the individual satellite is arranged to travel on an orbit that is closer to the Earth than a geostationary earth orbit (GEO) is and that is not restricted to reside on an equatorial plane of the Earth such that the satellite system has a full or substantial coverage of the Earth in providing WLAN services while reducing a latency experienced in data transmission between the individual MS and the Internet and reducing a signal power required in transmitting data from the individual MS to the individual satellite in comparison to using the GEO satellite as a relay in data transmission.

2. The satellite system of claim 1, wherein the preselected WLAN communication protocol is an IEEE 802.11-compliant WLAN protocol.

3. The satellite system of claim 1, wherein the preselected WLAN communication protocol is WiFi 6 protocol.

4. The satellite system of claim 1, wherein the plurality of GSC satellites is the plurality of satellites.

5. The satellite system of claim 1, wherein the orbit is a low earth orbit (LEO).

6. The satellite system of claim 1, wherein:
the individual satellite comprises:
one or more inter-satellite communication modules for providing direct satellite-to-satellite bidirectional communication in forming the multihop communication network; and
a first satellite-to-ground (STG) communication module for supporting bidirectional communication with the one or more MS's, the first STG module being configured to communicate with the individual MS under the preselected WLAN communication protocol;
and
the individual GSC satellite is installed with a second STG communication module for communicating with the GS.

7. The satellite system of claim 6, wherein the first STG communication module is configured to transmit and receive signals in the S band or the C band, or both.

8. The satellite system of claim 6, wherein the second STG communication module is configured to transmit and receive signals in the Ku band, the K band, the Ka band, the V band, or a combination thereof.

9. The satellite system of claim 6, wherein the first and second STG communication modules are configured to operate on different radio frequency bands in providing STG communication.

10. The satellite system of claim 6, wherein the one or more inter-satellite communication modules include a laser communication transceiver for enabling laser communication in Space.

11. The satellite system of claim 6, wherein the one or more inter-satellite communication modules include a radio transceiver for enabling millimeter wave communication in the V band.

12. The satellite system of claim 6, wherein the first STG communication module includes a phased array antenna for performing adaptive beamforming in the bidirectional communication with the one or more MS's.

13. The satellite system of claim 12, wherein the first STG communication module is further configured to track a direction-of-arrival (DOA) of an incoming signal sent from the individual MS to the individual satellite, and to configure the phased array antenna to steer an outgoing signal transmitted from the individual satellite to the individual MS along a direction opposite to the DOA.

14. The satellite system of claim 6, wherein in the individual GSC satellite, the first and second STG communication modules share a phased array antenna for performing adaptive beamforming in communicating with the one or more MS's and in communicating with the GS.

15. The satellite system of claim 1, wherein at least one satellite in the plurality of satellites is installed with a user authentication server connected to the multihop communication network such that the user authentication server is communicable with any satellite in the plurality of satellites, the user authentication server being configured to check a user identity of the individual MS so as to determine acceptance or denial of a request from the individual MS to access the Internet through the satellite system.

16. A wireless local area network (WLAN) system for providing WLAN services to a plurality of WLAN mobile stations (MS's) on Earth, the WLAN system comprising:
the satellite system for realizing a WLAN access point (AP) from Space as set forth in claim 1; and
a local router located on Earth for relaying data communicated between the WLAN AP from Space and the plurality of MS's, wherein the local router is configured to operate as an emulated WLAN AP for directly communicating with the plurality of MS's, and to operate as an emulated MS for directly communicating with the WLAN AP from Space.

17. The WLAN system of claim 16, wherein the local router is configured to track a first satellite in the plurality of satellites for directionally steering a radio beam sent from the local router toward the first satellite, the first satellite being visible to the local router and forming the WLAN AP from Space.

18. The WLAN system of claim 16, wherein the local router comprises:
an antenna array comprising a body frame and a plurality of horn-antenna elements distributed and mounted on the body frame for achieving beam steering, the body frame being substantially spherical in shape.

19. A satellite system for realizing a wireless local area network (WLAN) access point (AP) from Space, the satellite system comprising a plurality of satellites, wherein:
the plurality of satellites is configured and arranged to form a multihop communication network;
a plurality of ground-station-connecting (GSC) satellites is selected from the plurality of satellites, an individual GSC satellite being configured to communicate with a ground station (GS) that connects to the Internet such that the GS is communicable with an individual satellite in the plurality of satellites through the multihop communication network and a GS-visible satellite in the plurality of GSC satellites, the GS-visible satellite being visible to the GS;
the individual satellite is configured to communicate with one or more WLAN mobile stations (MS's) located on Earth and visible to the individual satellite under a preselected WLAN communication protocol, forming the WLAN AP from Space for enabling an individual MS to access the Internet without a need for a terrestrial Internet-connected AP nearby the individual MS;
the individual satellite is arranged to travel on an orbit, wherein at least a part of the orbit is closer to the Earth than a geostationary earth orbit (GEO) is; and
the individual satellite is further arranged such that communication with the one or more WLAN MS's, and with the GS if the individual satellite also belongs to the plurality of GSC satellites, is made only when the individual satellite is traveling on said part of the orbit; and
said part of the orbit is not restricted to reside on an equatorial plane of the Earth such that the satellite system has a full or substantial coverage of the Earth in providing WLAN services while reducing a latency experienced in data transmission between the individual MS and the Internet and reducing a signal power required in transmitting data from the individual MS to the individual satellite in comparison to using a geostationary earth orbit satellite as a relay in data transmission.

20. A wireless local area network (WLAN) system for providing WLAN services to a plurality of WLAN mobile stations (MS's) on Earth, the WLAN system comprising:
the satellite system for realizing a WLAN access point (AP) from Space as set forth in claim 19; and
a local router located on Earth for relaying data communicated between the WLAN AP from Space and the plurality of MS's, wherein the local router is configured to operate as an emulated WLAN AP for directly communicating with the plurality of MS's, and to operate as an emulated MS for directly communicating with the WLAN AP from Space.
